(19) United States
(12) Patent Application Publication
(10) Pub. No.: US 2006/0131240 A1
(43) Pub. Date: Jun. 22, 2006

(54) Process for treating solvents

(76) Inventors: Andrew R. Romano, Pittstown, NJ (US); Francis M. Houlihan, Millington, NJ (US)

Correspondence Address: ALAN P. KASS;AZ ELECTRONIC MATERIALS USA CORP., 70 MEISTER AVENUE, SOMERVILLE, NJ, 08876, US

(21) Appl. No.: 11/014,012

(22) Filed: Dec. 16, 2004

(51) Int. Cl. C02F 1/42

(52) U.S. Cl. 210/683

(57) ABSTRACT

The present invention provides for a process of treating organic solvents that are useful in the semiconductor industry by contacting the organic solvent with an anion exchange resin to remove anion contaminants.

The present invention provides a process for treating organic solvents. The process involves removing anion impurities from the solvent by contacting a solvent having anion impurities with an anion exchange resin. Suitable areas of interest for use of this invention include, but are not limited to, reducing anions that may interfere with chemical reactions taking place in organic solvents, as well as treating solvents for use in, for example, the food, pharmaceutical, cosmetic, cleaning and laundry, textile, paint and coatings, adhesives, pollution control, and electronic materials (semiconductor) industries.

### BACKGROUND OF THE INVENTION

Organic solvents are used in a variety of manufacturing processes and products; for example, in the food, cosmetic, pharmaceutical, paint and coatings, cleaning and laundry, textile, adhesives, pollution control, gasoline and fuel and motor oils, and electronic materials (semiconductor) fields. The organic solvents are used as both reaction media as well as solvents for compositions.

It is possible that the presence of anions in the organic solvents could impact the chemical reactions taking place therein by, for example, competing with catalytic surfaces or other reactive moieties within the reaction media. The presence of the anion could also impact the stability of various food, pharmaceutical, cosmetic, paint and coatings, cleaning and laundry, textile, adhesives, pollution control, gasoline and fuel and motor oils, and electronic materials (semiconductors) products because of the anions interfering with the complete composition.

One area of interest in reducing the presence of anions in organic solvents is in the electronic materials (semiconductor) field.

Photoresist compositions are used in microlithography processes for making miniaturized electronic components, such as in the fabrication of computer chips and integrated circuits. Generally, in these processes, a thin coating of a film of a photoresist composition is first applied to a substrate material, such as silicon wafers used for making integrated circuits. The coated substrate is then baked to evaporate any solvent in the photoresist composition and to fix the coating onto the substrate. The baked-coated surface of the substrate is next subjected to an image-wise exposure to radiation.

This radiation exposure causes a chemical transformation in the exposed areas of the coated surface. Visible light, ultraviolet (UV) light, electron beam and X-ray radiant energy are radiation types commonly used today in microlithographic processes. After this image-wise exposure, the coated substrate is treated with a developer solution to dissolve and remove either the radiation-exposed (in the case of positive photoresist) or the unexposed (in the case of negative photoresist) areas of the coated surface of the substrate.

There are two types of photoresist compositions, negative-working and positive-working. When negative-working photoresist compositions are exposed image-wise to radiation, the areas of the resist composition exposed to the radiation become less soluble to a developer solution (e.g. a cross-linking reaction occurs) while the unexposed areas of the photoresist coating remain relatively soluble to such a solution. Thus, treatment of an exposed negative-working resist with a developer causes removal of the non-exposed areas of the photoresist coating and the creation of a negative image in the coating thereby uncovering a desired portion of the underlying substrate surface on which the photoresist composition was deposited.

On the other hand, when positive-working photoresist compositions are exposed image-wise to radiation, those areas of the photoresist composition exposed to the radiation become more soluble to the developer solution (e.g. a rearrangement reaction occurs) while those areas not exposed remain relatively insoluble to the developer solution. Thus, treatment of an exposed positive-working photoresist with the developer causes removal of the exposed areas of the coating and the creation of a positive image in the photoresist coating. Again, a desired portion of the underlying substrate surface is uncovered.

After this development operation, the now partially unprotected substrate may be treated with a substrate-etchant solution or plasma gases and the like. The etchant solution or plasma gases etch that portion of the substrate where the photoresist coating was removed during development. The areas of the substrate where the photoresist coating still remains are protected and, thus, an etched pattern is created in the substrate material which corresponds to the photomask used for the image-wise exposure of the radiation. Later, the remaining areas of the photoresist coating may be removed during a stripping operation, leaving a clean etched substrate surface. In some instances, it is desirable to heat treat the remaining photoresist layer, after the development step and before the etching step, to increase its adhesion to the underlying substrate and its resistance to etching solutions.

Positive working photoresist compositions are currently favored over negative working resists because the former generally have better resolution capabilities and pattern transfer characteristics. Photoresist resolution is defined as the smallest feature which the resist composition can transfer from the photomask to the substrate with a high degree of image edge acuity after exposure and development. In many manufacturing applications today, resist resolution on the order of less than one micron is quite common. In addition, it is almost always desirable that the developed photoresist wall profiles be near vertical relative to the substrate. Such demarcations between developed and undeveloped areas of the resist coating translate into accurate pattern transfer of the mask image onto the substrate.

Ion contamination has been a problem for a long time in the fabrication of high density integrated circuits, computer hard drives and computer chips, often leading to increased defects, yield losses, degradation and decreased performance.

While much focus has been on metal ion reduction, little focus has been directed to the reduction in anion reduction. Some anions, for example, dissolved halides, phosphates, nitrates, chromates, borates or other materials, can affect the doping characteristics of the semiconductor circuits.

While some attempts have been made to reduce anion contamination in resins used to make photoresist compositions, often times, the contamination comes from the solvents in which the resins are made and/or the solvents used to make the photoresist compositions that ultimately used in the production of semiconductors. The anion contaminates can come from the methods used to make and purify the solvents and/or from the containers in which the solvents are shipped.

In producing sophisticated semiconductor and other microelectronic devices, it has become increasingly important to provide liquid photoresist formulations, which include anti-reflective coatings, anti-reflective protective layer coatings, photoresist compositions, interlayer coatings, and the like, where the solvents used in the various stages of production related thereto have anion contamination levels below 50 ppb. The present invention provides such a method for producing such solvents.

### SUMMARY OF THE INVENTION

The present invention relates to a process for removing anionic contaminants from an organic solvent, the process comprising the steps of providing an anion exchange resin; contacting the organic solvent with the anion exchange resin; and separating the organic solvent from the anion exchange resin. Contacting the organic solvent with the anion exchange resin can be accomplished, for example, by passing the organic solvent through a column containing the anion exchange resin; or passing the organic solvent through a filter sheet containing the anion exchange resin; or by mixing the organic solvent and anion exchange resin together (for example, in a suitable container put on a shaker or roller).

The removed anionic contaminants include halides, phosphates, nitrates, borates, sulfates and organic sulfonic acids. The process of the present invention reduces, after contacting the organic solvent with the anion exchange resin, the concentration of anions in the organic solvent to less than 50 ppb, even to less than 25 ppb, and even to less than 10 ppb.

### DETAILED DESCRIPTION OF THE INVENTION

The present invention relates to a process for removing anionic contaminants from an organic solvent, the process comprising the steps of providing an anion exchange resin; contacting the organic solvent with the anion exchange resin; and separating the organic solvent from the anion exchange resin. Contacting the organic solvent with the anion exchange resin can be accomplished, for example, by passing the organic solvent through a column containing the anion exchange resin; or passing the organic solvent through a filter sheet containing the anion exchange resin; or by mixing the organic solvent and anion exchange resin together (for example, in a suitable container put on a shaker or roller).

The removed anionic contaminants include halides, phosphates, nitrates, borates, sulfates and organic sulfonic acids. The process of the present invention reduces, after contacting the organic solvent with the anion exchange resin, the concentration of anions in the organic solvent to less than 50 ppb, even to less than 25 ppb, and even to less than 10 ppb.

There are a variety of solvents that are used in the food, cosmetic, pharmaceutical, paint and coatings, cleaning and laundry, textile, adhesives, pollution control, gasoline and fuel and motor oils, and electronic materials (semiconductor) fields. For example, in the electronic materials (semiconductor) field, organic solvents are used in both the manufacture of the resins that go into making photoresist compositions as well as those used in manufacturing the final photoresist compositions which are used in the semiconductor area. Examples of such solvents include: ketones such as acetone, methyl ethyl ketone, methyl isobutyl ketone, cyclohexanone, isophorone, methyl isoamyl ketone, 2-heptanone 4-hydroxy, and 4-methyl 2-pentanone; C₁ to C₁₀ aliphatic alcohols such as methanol, ethanol, and propanol; aromatic group containing-alcohols such as benzyl alcohol; cyclic carbonates such as ethylene carbonate and propylene carbonate; aliphatic or aromatic hydrocarbons (for example, hexane, toluene, xylene, etc and the like); cyclic ethers, such as dioxane and tetrahydrofuran; ethylene glycol; propylene glycol; hexylene glycol; ethylene glycol monoalkylethers such as ethylene glycol monomethylether, ethylene glycol monoethylether; ethylene glycol alkylether acetates such as methylcellosolve acetate and ethylcellosolve acetate; ethylene glycol dialkylethers such as ethylene glycol dimethylether, ethylene glycol diethylether, ethylene glycol methylethylether, diethylene glycol monoalkylethers such as diethylene glycol monomethylether, diethylene glycol monoethylether, and diethylene glycol dimethylether; propylene glycol monoalkylethers such as propylene glycol methylether, propylene glycol ethylether, propylene glycol propylether, and propylene glycol butylether; propylene glycol alkyletheracetates such as propylene glycol methylether acetate, propylene glycol ethylether acetate, propylene glycol propylether acetate, and propylene glycol butylether acetate; propylene glycol alkyletherpropionates such as propylene glycol methyletherpropionate, propylene glycol ethyletherpropionate, propylene glycol propyletherpropionate, and propylene glycol butyletherpropionate; 2-methoxyethyl ether (diglyme); solvents that have both ether and hydroxy moieties such as methoxy butanol, ethoxy butanol, methoxy propanol, and ethoxy propanol; esters such as methyl acetate, ethyl acetate, propyl acetate, and butyl acetate methyl-pyruvate, ethyl pyruvate; ethyl 2-hydroxy propionate, methyl 2-hydroxy 2-methyl propionate, ethyl 2-hydroxy 2-methyl propionate, methyl hydroxy acetate, ethyl hydroxy acetate, butyl hydroxy acetate, methyl lactate, ethyl lactate, propyl lactate, butyl lactate, methyl 3-hydroxy propionate, ethyl 3-hydroxy propionate, propyl 3-hydroxy propionate, butyl 3-hydroxy propionate, methyl 2-hydroxy 3-methyl butanoic acid, methyl methoxy acetate, ethyl methoxy acetate, propyl methoxy acetate, butyl methoxy acetate, methyl ethoxy acetate, ethyl ethoxy acetate, propyl ethoxy acetate, butyl ethoxy acetate, methyl propoxy acetate, ethyl propoxy acetate, propyl propoxy acetate, butyl propoxy acetate, methyl butoxy acetate, ethyl butoxy acetate, propyl butoxy acetate, butyl butoxy acetate, methyl 2-methoxy propionate, ethyl 2-methoxy propionate, propyl 2-methoxy propionate, butyl 2-methoxy propionate, methyl 2-ethoxypropionate, ethyl 2-ethoxypropionate, propyl 2-ethoxypropionate, butyl 2-ethoxypropionate, methyl 2-butoxypropionate, ethyl 2-butoxypropionate, propyl 2-butoxypropionate, butyl 2-butoxypropionate, methyl 3-methoxypropionate, ethyl 3-methoxypropionate, propyl 3-methoxypropionate, butyl 3-methoxypropionate, methyl 3-ethoxypropionate, ethyl 3-ethoxypropionate, propyl 3-ethoxypropionate, butyl 3-ethoxypropionate, methyl 3-propoxypropionate, ethyl 3-propoxypropionate, propyl 3-propoxypropionate, butyl 3-propoxypropionate, methyl 3-butoxypropionate, ethyl 3-butoxypropionate, propyl 3-butoxypropionate, and butyl 3-butoxypropionate; oxyisobutyric acid esters, for example, methyl-2-hydroxyisobutyrate, methyl α-methoxyisobutyrate, ethyl methoxyisobutyrate, methyl α-ethoxyisobutyrate, ethyl α-ethoxyisobutyrate, methyl β-methoxyisobutyrate, ethyl α-methoxyisobutyrate, methyl β-ethoxyisobutyrate, ethyl β-ethoxyisobutyrate, methyl β-isopropoxyisobutyrate, ethyl β-isopropoxyisobutyrate, isopropyl β-isopropoxyisobutyrate, butyl β-isopropoxyisobutyrate, methyl β-butoxyisobutyrate, ethyl β-butoxyisobutyrate, butyl β-butoxyisobutyrate, methyl α-hydroxyisobutyrate, ethyl α-hydroxyisobutyrate, isopropyl α-hydroxyisobutyrate, and butyl α-hydroxyisobutyrate; solvents that have both ether and hydroxy moieties such as methoxy butanol, ethoxy butanol, methoxy propanol, and ethoxy propanol; and other solvents such as dibasic esters, and gamma-butyrolactone.

Examples of anion exchange materials are known and disclosed in Samuelson, Ion Exchange Separations in Analytical Chemistry, John Wiley & Sons, New York, 1963, Chapter 2, incorporated herein by reference. Suitable anion exchange resins include quaternary ammonium group-containing phenolic resins, quaternary ammonium group-containing styrene-divinyl benzene copolymers, aromatic polyamines, polyethyleneamine, and the like. Further examples include anion exchange resins are resins having structurally bound quaternary ammonium hydroxide exchange groups such as polystyrene-divinylbenzene resins substituted with tetramethyl ammonium hydroxide. Another example of an anion exchange resin is crosslinked polystyrene having quaternary ammonium hydroxide substitution such as those ion exchange resins sold under the trade names AMBERLYST A26-OH by Rohm & Haas Company and Dow G51-OH by Dow Chemical Company. Another is a quaternary ammonium styrene-divinyl benzene resin called AMBERLYST A-27 and made by Rohm & Haas Company. Another is an aliphatic amino group-containing styrene-divinyl benzene resin called AMBERLYST A-21 which is also produced by Rohm & Haas. A filter containing a suitable anion exchange resin can be obtained from Cuno as 40K Filter.

The anion exchange resin can be in fibrous, granular or like form.

Contacting the organic solvent with the anion exchange resin can be accomplished, for example, by passing the organic solvent through a column containing the anion exchange resin and collecting the organic solvent in a suitable container; or passing the organic solvent through a filter sheet containing an anion exchange resin and collecting the organic solvent in a suitable container; or by mixing the organic solvent and anion exchange resin together (for example, in a suitable container put on a shaker or roller). The organic solvent is collected in a suitable container separately from the anion exchange resin as it passes through the column containing the anion exchange resin or through the filter sheet. Where the organic solvent is mixed with the anion exchange resin (e.g., by shaking or rolling in a suitable container), the mixture can be filtered through a suitable filter where the anion exchange resin will remain on the filter and the organic solvent will pass through and collected in a suitable container.

This example illustrates a process for removing anions from an organic solvent using an anion exchange resin.

One hundred grams of pentanol (obtained from Aldrich) was passed through a 40K filter (from Cuno) and collected in a non-borosilicate container. Samples of the pentanol that was passed through the filter and pentanol that was not passed through the filter were analyzed for boron content (representative of borate levels).

The sample of pentanol not passed through the anion exchange filter contained 155±2 ppb (ng/g) of boron. The sample of pentanol that was passed through the anion exchange filter contained 25±0.3 ppb (ng/g) of boron.

As a comparison, an equivalent sample of pentanol was passed through a cationic exchange resin filter (40 Q from Cuno) and analyzed for boron. This sample contained 147±2 ppb (ng/g) of boron.

The foregoing description of the invention illustrates and describes the present invention. Additionally, it is to be understood that the invention is capable of use in various other combinations, modifications, and environments and is capable of changes or modifications within the scope of the inventive concept as expressed herein, commensurate with the above teachings and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

1. A process for removing anionic contaminants from an organic solvent, the process comprising the steps of providing an anion exchange resin; contacting the organic solvent with the anion exchange resin; and separating the organic solvent from the anion exchange resin.

2. The process of claim 1 where the removed anionic contaminants are selected from the group consisting of halides, phosphates, nitrates, borates, sulfates and organic sulfonic acids.

3. The process of claim 1, wherein after separating the organic solvent from the anion exchange resin, the organic solvent has a concentration of anions that is less than 50 ppb.

4. The process of claim 3, wherein after separating the organic solvent from the anion exchange resin, the organic solvent has a concentration of anions that is less than 25 ppb each.

5. The process of claim 4, wherein after separating the organic solvent from the anion exchange resin, the organic solvent has a concentration of anions that is less than 10 ppb each.

6. The process of claim 1 wherein the step of contacting the organic solvent with the anion exchange resin is accomplished by passing the organic solvent through a column containing the anion exchange resin.

7. The process of claim 1 wherein the step of contacting the organic solvent with the anion exchange resin is accomplished by passing the organic solvent through a filter sheet containing anion exchange resin.

8. The process of claim 1 wherein the step of contacting the organic solvent with the anion exchange resin Is accomplished by mixing the organic solvent and anion exchange resin together.

9. The process of claim 1 wherein the separated organic solvent is used in the food, cosmetic, pharmaceutical, paint and coatings, cleaning and laundry, textile, adhesives, pollution control, gasoline and fuel and motor oils, and semiconductor fields.
